(19) United States
(12) Patent Application Publication
(10) Pub. No.: US 2017/0193466 A1
(43) Pub. Date: Jul. 6, 2017

(54) ELECTRONIC SYSTEM FOR ROUTING MARKETPLACE TRANSACTIONS

(71) Applicant: Jonathan A Clark, San Jose, CA (US)

(72) Inventor: Jonathan A Clark, San Jose, CA (US)

(21) Appl. No.: 15/396,814

(22) Filed: Jan. 2, 2017

Related U.S. Application Data
(63) Continuation of application No. 62/274,148, filed on Dec. 31, 2015.

(51) Int. Cl. G06Q 20/10; H04L 29/06; G06Q 40/02

(52) U.S. Cl. CPC G06Q 20/10; G06Q 40/02; H04L 63/10

(57) ABSTRACT

An apparatus, system, and method for routing merchant transactions to acquirers within a payment system. A secure portal enables acquirers and proxies to define service offerings for merchants (resource link library), to sign up merchants, to define token formats, etc. The secure portal allows merchants to view service offers (resource link library), to sign up for a desired acquirer, to define transaction services and metrics (request link library), and/or to define logic for how secure portal automatically chooses an acquirer for merchant. Transactions are programmably implemented in real-time in electronic transaction device that couples one or more transaction acquirers with one or more merchants via a transaction gateway computer (“TGC”). A match engine parses a given transaction orderset (“TO”) from a merchant across one or more acquirers simultaneously via the transaction gateway computer based on at least one of the plurality of resource metrics.

### CROSS-REFERENCE TO RELATED APPLICATIONS

This application claims priority to provisional application(s): Ser. No. 62/274,148 filed Dec. 31, 2015, entitled “ELECTRONIC SYSTEM FOR ROUTING MARKETPLACE TRANSACTIONS,” and commonly owned with the present application; which said provisional application(s) are also incorporated by reference herein in its entirety.

Where a definition or use of a term in a reference, which is incorporated by reference herein, is inconsistent or contrary to the definition of that term provided herein, the definition of that term provided herein applies and the definition of that term in the reference does not apply.

### FIELD OF TECHNOLOGY

This disclosure relates generally to the technical field of electronic apparatus for processing financial transactions, and in one example embodiment, this disclosure relates to a method, apparatus and system for routing merchant transactions to acquirers automatically, programmably, and flexibly within a payment system.

### BACKGROUND

Millions of electronic financial transactions occur every day from credit card charges and other forms of electronic banking. The payment card industry (PCI) provides compliance standards for security and privacy, while each acquirer, or credit handler, specifies their own proprietary protocol and formatting of a transaction request that satisfies the PCI standards. A consumer can initiate a charge at a merchant, whether at a brick and mortar establishment or an online seller, to purchase a good or service. An acquirer acts as the middle-person to enable the tracking and management of the electronic transaction to the banking institution tied to the consumer's purchase, e.g., the bank issuing the credit card.

Because of the secure nature of the transaction, the confidential financial information involved, and the risk of hacking or identity theft, the best system that currently exists uses a very direct 1:1 relationship between a merchant and an acquirer with acquirer-specific software code and formatting. However, the unintended consequence is that merchants find it difficult to compare performance metrics, to switch between acquirers, and to test innovative systems in an easy, cost-effective manner. That is, the nature, quantity, and dollar amount of the transactions is not readily visible or attainable so that a new acquirer would be able to bid for offering the service. However, financial institutions typically look for methods to reduce cost and administrative overhead in transaction processing. Savings usually translate into near total profit.

A protocol exists for implementing an electronic purchase using a credit or debit card. As described by government regulation of transactions, multiple different paths are possible. The parties for the transaction could be one of hundreds of acquirers or issuers or one of millions of merchants and consumers. Further, there are many other ways the arrangements can be structured. For example, in some transactions, the acquiring institution (bank) and the issuing institution are the same. In addition, the timing of the payment to the merchant from the acquiring institution varies. Some acquiring institutions pay select merchants prior to receiving funds from the issuing bank, thereby increasing the acquiring institution's credit and liquidity exposure. However, payment from the acquiring institution to the merchant often occurs shortly after the acquiring institution receives credit from the issuing institution.

The presence of third-party organizations coupled with the acquiring bank's ability to sub-license the entire merchant program, or part thereof, and the issuing bank's ability to sub-license the entire issuing program, or part thereof, to other entities also introduces complexities to the transaction and fund flows. For example, because the cost of technology infrastructure and the level of transaction volume are high for acquiring banks, most small acquiring banks rely on third-party card processors to perform the functions. In addition, issuing banks often use card processors to conduct several of their services. In intra-processor transactions, the same third party processes for both the acquiring bank and the issuing bank. Under the by-laws and operating rules/regulations of the Associations, the issuing banks and acquiring banks are responsible for the actions of their contracted third parties, respectively.

A merchant submits sales transactions to its acquiring bank by one of two methods. Large merchants often have computer equipment that transmits transactions directly to the acquiring bank or its card processor. Smaller merchants usually submit transactions to a vendor that collects data from several merchants and then transmits transactions to the acquiring banks.

### SUMMARY

An apparatus, system, and method for routing merchant transactions to acquirers automatically, programmably, and flexibly within a payment system is disclosed. A secure portal enables registered acquirers, or proxies, to register, to define service offerings for merchants (in a resource link library), to sign up with merchants (if a merchant selects them), to define token formats, etc. The secure portal is also available to registered merchants allows them to view service offers from acquirers (resource link library), to sign up for a desired acquirer, to define transaction services and metrics (request link library) for transaction services desired by the merchant, and/or to define logic for how the secure portal can automatically choose an acquirer for the merchant on a single or an ongoing basis. These interactions by the merchant and the acquirers within the portal can be changed within agreed-to bounds, at will and then programmably implemented in real-time. The choices made by both acquirer and merchant in the portal are implemented in an electronic transaction device that couples one or more transaction acquirers with one or more merchants via a transaction gateway computer (“TGC”). A match engine parses a given transaction orderset (“TO”) from a merchant across one or more acquirers simultaneously via the transaction gateway computer based on at least one of the plurality of resource metrics.

The electronic transaction device includes a translator logic for translating a merchant transaction format to one or more different acquirer transaction format. The translator logic translates in parallel at least one subset of the given transaction orderset to a transaction format that is different from a transaction format of another subset of the given TO. Conveniently, the merchant transaction format for the transaction orderset is not required to be changed. Additionally, the translator is programmable to modify the at least one subset of the given transaction orderset from a first format to a second format in real time.

Optionally, the electronic transaction device also includes a token interface coupled to the transaction gateway, wherein the token interface communicates with a token as a service (“TAAS”) exchange on the input interface, associates the token with the given acquirer; and transmits the transaction and the token from the output interface to a banking intuition for further processing.

### BRIEF DESCRIPTION OF THE VIEW OF DRAWINGS

Example embodiments are illustrated by way of example and not limitation in the figures of the accompanying drawings, in which like references indicate similar elements and in which:

FIG. 1 is a functional block diagram for routing merchant transactions to acquirers automatically, programmably, and flexibly within a payment system, according to one or more embodiments.

FIG. 2 is an electronic device for routing merchant transactions to acquirers automatically, programmably, and flexibly within a payment system, according to one or more embodiments.

FIG. 3 is a block diagram of a transaction gateway for coupling one or more transaction acquirers with one or more merchants, according to one or more embodiments.

FIGS. 4A-4B are functional block diagrams of a comparator for evaluating different metrics, including new or changed proxy metric, resource metrics, and request metrics for decision-making actions to route the transaction requests, according to one or more embodiments.

FIG. 5 is a flowchart for routing merchant transactions to acquirers automatically, programmably, and flexibly within a payment system according to one or more embodiments.

Other features of the present embodiments will be apparent from the accompanying drawings and from the detailed description that follows.

### DETAILED DESCRIPTION

A method, apparatus and system for managing acquirer transactions (routing merchant transactions to acquirers) automatically, programmably, and flexibly within a payment system and in a secure environment is disclosed. In the following description, for the purposes of explanation, numerous specific details are set forth in order to provide a thorough understanding of the various embodiments. It will be evident, however to one skilled in the art that various embodiments may be practiced without these specific details.

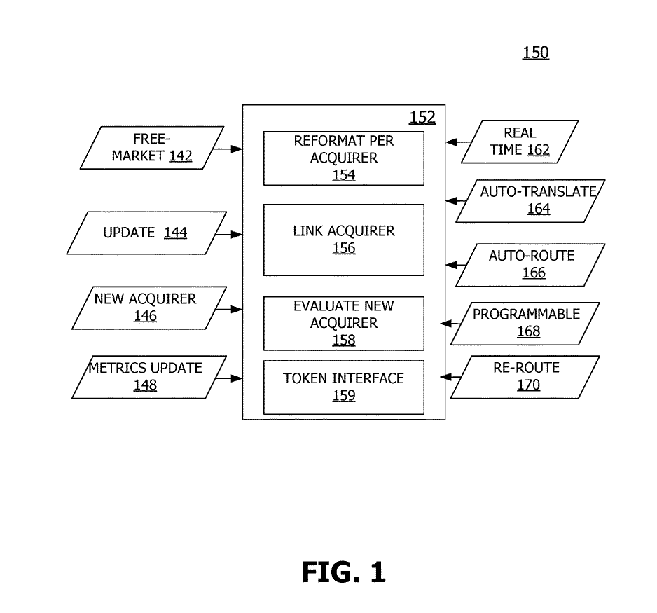

Referring now to FIG. 1, a functional block diagram is shown for routing merchant transactions to acquirers automatically, programmably, and flexibly within a payment system, according to one or more embodiments. A system for managing acquirer transactions (routing merchant transactions to acquirers) automatically, programmably, and flexibly within a payment system and in a secure environment is implemented using at least one of the functions of: reformatting 154 a request, typically from a merchant, per an acquirer's format needs; linking 156 an acquirer to a merchant processing a transaction; evaluating 158 a new acquirer, his transaction resource solutions (“TRS”) which includes his resource metrics; and interfacing 159 with a token service. Regarding the reformatting function 154 per acquirer, this function would be performed in real time 162, and would automatically translate from a format used by a merchant to submit a new transaction request (e.g., an approval for a purchase) to a format required by the acquirer selected by the merchant to process the transaction request. After translating the format of the transaction request, the system should provide the functionality to route automatically 166 the transaction request to the correct IP address of the chosen acquirer.

Different transaction requests can be slated to a variety of different acquirers, even if the requests arise from a same merchant. Consequently, functions of the system detect and evaluate the correct acquirer, and his transaction format, from the properties of the request and other apriori information and instructions from the merchant. If a merchant changes the acquirer used for a portion or all of his transaction orderset (a bundle of transactions grouped for a given purpose, e.g., geographical location, date, amount of transaction, type of transaction service, profile of a user, etc.), the functions 154-159 should adapt and function in real time to reprogram the system on the fly to route the merchant transactions to the correct acquirers and in the correct format. Changes in the merchant/acquirer matching can arise because a merchant introduces a resource metric update 148 (e.g., a new promotion or service offering), a new acquirer 146 desires to bid on the service with a competitive set of resource metrics (free market 142 access without artificial boundaries and barriers of infrastructure, proprietary formatting requirements, lack of parsing capability in a transactional orderset, etc.), or some other update 144, e.g., a merchant update or new resource requirement, a fail-over situation with a communication system or a past acquirer, denial-of-service, etc. or a network or Internet update or failure, or any other update that would cause a new efficiency or cost reduction in the processing or routing of merchant transactions to acquirers.

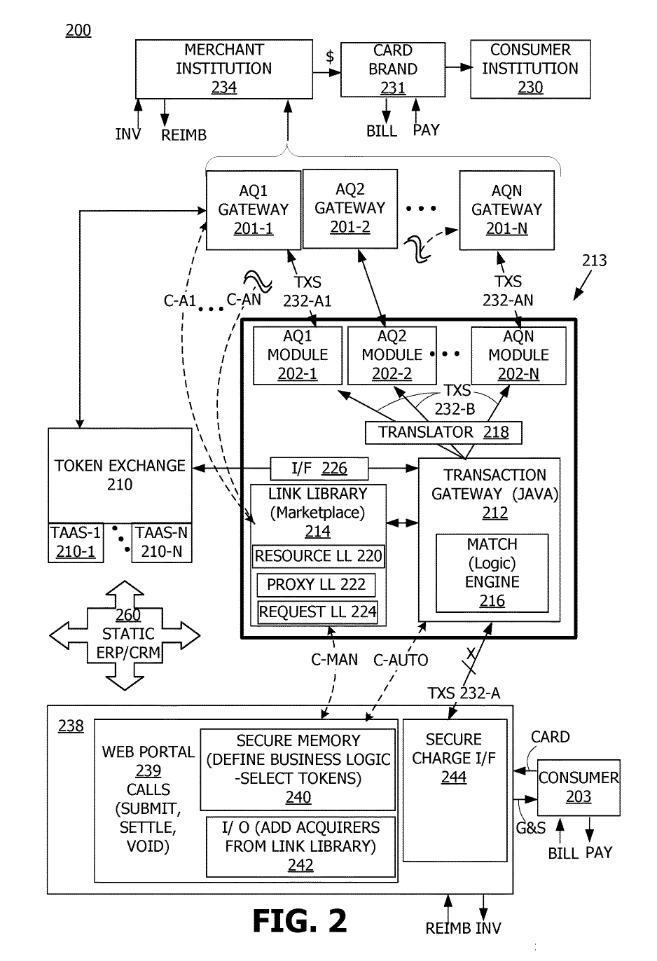

Referring now to FIG. 2, an electronic device 213 is shown for routing merchant transactions to acquirers automatically, programmably, and flexibly within a payment system, according to one or more embodiments. Device 213 is part of a financial transaction system 200 that includes a merchant 238, a token exchange 210, one or more gateways 201-1 to 201-N, merchant institution 234, card brand institutions 231, and a consumer institution 232.

An electronic transaction device 213 includes a transaction gateway computer 212 (“TGC”) which is a Java engine in one embodiment, for coupling one or more transaction acquirers AQ1 gateway 202-1 through AQN gateway 201-N, with one or more merchants, e.g., 238; a resource link library (“RLL”) 220 including a plurality of transaction resource solutions (“TRS”) (Table 1) from one or more acquirers, with each TRS having a plurality of resource metrics (Table 1); and a match engine (“ME”) 216. Match engine 216 is configured to parse a given transaction orderset (“TO”) (Table 2) from a merchant across one or more acquirers simultaneously via the transaction gateway computer 212 based on at least one of the plurality of resource metrics.

The electronic transaction device 213 includes a translator logic 218 for translating a merchant transaction format to one or more different acquirer transaction format. The translator logic translates in parallel at least one subset of the given transaction orderset to a transaction format that is different from a transaction format of another subset of the given TO. Conveniently, the merchant transaction format for the transaction orderset is not required to be changed by the merchant herself. Additionally, the translator 218 is programmable to modify the at least one subset of the given transaction orderset from a first format to a second format in real time, e.g., by swapping a destination routing of the transaction to a different acquirer module in device 213 that is paired with the different acquirer.

Device 213 is interposed between the merchant 238 and the acquirer gateways 201-1 to 201-N in order to intercept and manage a transaction request, thus providing a new layer of programmability, standardization, and flexibility in selecting, changing, and monitoring the routing and processing of merchant transactions to acquirers. Past systems simply routed a given merchant secure charge interface 244 directly to a given acquirer gateway, and thus, were locked-in to a given acquirer with very little opportunity for easy and inexpensive changes to different acquirer and a built in barrier against a free-market operation having inherent benefits of innovation, cost reduction, and improved service.

Transaction gateway 212 performs the function of evaluating transaction requests 232-A sent from one or more merchants, e.g., merchant 238, to determine what format the request is, what the proper acquirer should be for each single transaction request, and routing that request appropriately to a translator 218, as needed, and then to the correct interface module 202-1 through 202-N that is paired with the desired acquirer, e.g., AQ-1 201-1 to AQ-N 201-N gateway to further process the transaction request. Transaction gateway 212 mimics a standard acquirer's interface to be compatible with the merchant's legacy secure charge interface 244. In one embodiment, transaction gateway 212 utilizes a single standard acquirer's interface, which it would require all merchants to use for interfacing device 213. In another embodiment, different acquirer protocols can be received by device 213, with an engine at the interface to interpret and adapt the different layers of the Open Systems Interconnection (“OSI”) Reference Model, e.g., layers 5 session, 6 presentation, and 7 application.

Acquirer interface modules AQ1 202-1 thru AQN 202-N disposed in device 213 are programmed to interface with its respective paired acquirer gateways AQ1 201-1 thru AQN 201-N in terms of communication protocol and packet formatting. Many changes that a gateway 201-1 thru 201-N may require can be dealt with at the acquirer interface modules 202-1 thru 202-N, thus reducing cost and upgrades to a less frequent device 213, which services many times more merchant interfaces 244. Because of the flexibility in programming device 213 to interface different protocols, the underlying customer resource management (“CRM”), aka enterprise resource planning (“ERP”) can remain static, despite a merchant's desire to change from one acquirer to another, which themselves may utilize different CRM software.

Within transaction gateway 212 is a match engine (“ME”) 216 logic that performs the packet evaluation for routing and formatting or that performs a decision operation for assigning an acquirer to a merchant, and /or performs a transition operation from a present acquirer for a merchant to a new acquirer, or a new acquirer service offering, for a single transaction request, a subset of the transactional orderset, or the entire orderset itself of a merchant. ME 212 selectively and simultaneously parses the given transaction orderset as i) a first subset (Table 2, row 2, subset A of Lacy's) of a given merchant (238) to a first transaction acquirer, (PlanetPay e.g., AQ1 gateway 201-1) based on at least one of a plurality of resource metrics (Table 1, row 3, flat ‘cost’ metric for PlanetPay) of the first transaction acquirer that satisfies, or is best in class of, at least one of a first set of request metrics (e.g., cost or volume metrics of Table 3) of the given merchant; and ii) a second subset (Table 2, row 3, subset B of Lacy' s)of the given merchant to a second transaction acquirer (2^{nd} Data acquirer e.g., AQ2 gateway 201-2) based on at least one of a plurality of resource metrics (Table 1, row 4, ‘unlimited’ volume, for North America (“NA”)) for the second acquirer satisfying at least one of a second set of request metrics of the given merchant. Additionally, ME 216 can selectively reroute the parsing of the given transaction orderset in real time from a first set of one or more acquirers (i.e., Table 2) at a first set of IP addresses to a second set of one or more acquirers (not shown) at a second set of IP address, where at least one of the acquirers in the second set is different from those in the first set; and the rerouting by the match engine does not require changing an underlying resource planning system (260).

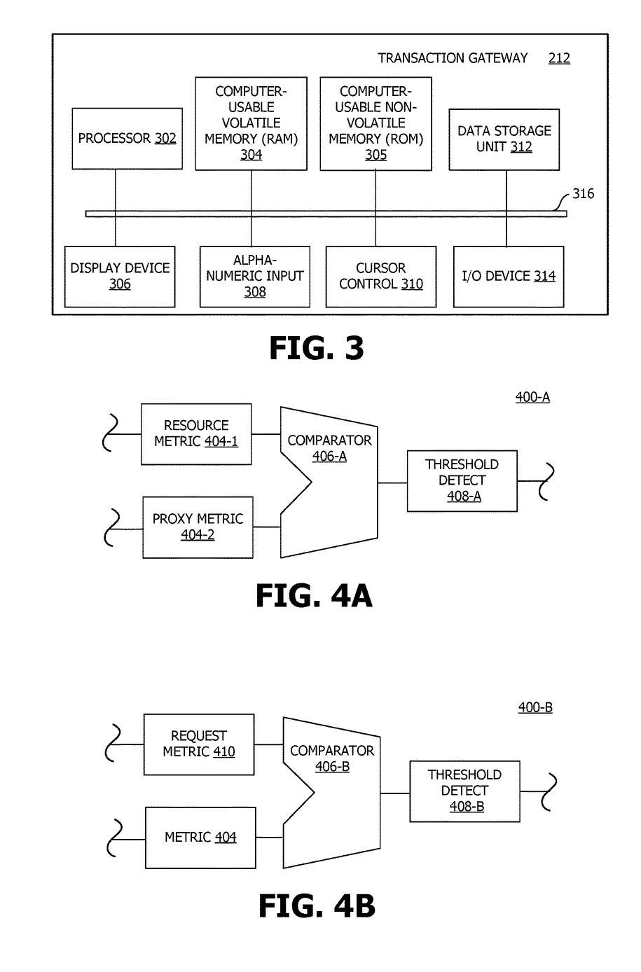

The electronic transaction device further includes a proxy link library (“PLL”) (222) comprising at least one proxy resource solution (“PRS”) (Table 4) of an acquirer, with each proxy solution having a plurality of proxy metrics. The match engine comprises a comparative logic (that is a logical function implemented by a microprocessor using code in memory as shown in FIG. 3, or is implemented by hardware logic for faster processing (not shown)) wherein the match engine identifies when a change is made to a proxy metric and when a new proxy resource solution is entered in the PLL (Table 4); the comparative logic compares the new or changed proxy metrics in proxy LL 222 against resource metrics in resource LL 220 in the LL 214; and ME 216 receives an instruction from a user to implement a supra proxy resource solution (e.g., Table 4, row 3 ‘ValueGuy’) that has at least one proxy metric that exceeds a resource transaction solution (e.g., ValueGuy being 75% the cost of the benchmark); the match engine substitutes the PRS for the TRS by rerouting the parsing of the given transaction orderset in real time.

Optionally, the electronic transaction device includes a request link library (“QLL”) (224) comprising one or more transaction request ordersets from one or more merchants, with each transaction request orderset having a plurality of request metrics (Table 3). The match engine automatically implements the supra proxy solution based on a match level set by the supra proxy solution is implemented for at least one subset of the given transaction orderset of a given merchant, as described above.

Optionally, the electronic transaction device 213 also includes a token interface 226 coupled to the transaction gateway, wherein the token interface communicates with a token as a service (“TAAS”) exchange on the input interface, associates the token with the given acquirer; and transmits the transaction and the token from the output interface to a banking intuition for further processing. An example of coding for token interchange is described below.

Device 213 allows a secure marketplace that protects both sensitive data provided to device 213 from merchants, acquirers, and proxies from exposure outside device 213. Device 213 is designed in a modular fashion to allow future interfaces with other gateways not yet defined.

### Electronic Processing Platform

Referring now to FIG. 3, a block diagram is shown of a transaction gateway for coupling one or more transaction acquirers with one or more merchants, according to one or more embodiments. Exemplary computing device 300 includes components and functionality that can be applied to several devices in the system 200 such as a personal computer of client, e.g., client A 302-A, mobile device, e.g., client B 302-B, mobile computer, e.g., client n 302-n, minicomputer, mainframe, server, e.g., 206, 210-A through 210-C, etc. each of which are capable of executing instructions to accomplish the functions and operations described herein. Computing device 300 includes components such as a processor 302 coupled to a memory 304, 305, and/or 312. In particular, processor 302 can be a single or multi-processor core, for processing data and instructions. Memory 304, 305, and/or 312 are used for storing and providing information, data, and instructions, including in particular computer usable volatile memory 304, e.g. random access memory (RAM), and/or computer usable non-volatile memory 305, e.g. read only memory (ROM), and/or a data storage 312, e.g., flash memory, or magnetic or optical disk or drive. Computing device 300 also includes optional inputs, such as: alphanumeric input device 308, such as: a keyboard or touch screen with alphanumeric, function keys, object driven menus; a keypad button, a microphone with voice recognition software running on a processor, or any device allowing a player to respond to an input; or an optional cursor control device 310, such as a roller ball, trackball, mouse, etc., for communicating user input information and command selections to processor 302; or an optional display device 306 coupled to bus for displaying information; and an optional input/output (I/O) device 314 for coupling system with external entities, such as a modem for enabling wired or wireless communications between system and an external network such as the Internet, a local area network (LAN), wide area network (WAN), virtual private network (VPN), etc. Coupling medium 316 of components can be any medium that communicates information, e.g., wired or wireless connections, electrical or optical, parallel or serial bus, etc.

The computing device is only one example of a suitable computing environment and is not intended to suggest any limitation as to the scope of use or functionality of the present technology. The clients 302-A through 302-n can be smart devices, with sufficient processors, memory, graphics, and input/output (I/O) capabilities to operate their respective portion of the gaming software. Alternatively, clients 302-A through 302-n can be a thin client, e.g., a dumb device, which only has a capability or is only used to a capability of displaying results and accepting inputs. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Referring now to FIGS. 4A-4B, functional block diagrams are shown of a comparator for evaluating different metrics, including new or changed proxy metric, resource metrics, and request metrics for decision-making actions to route the transaction requests, according to one or more embodiments. Referring to FIG. 4A, specifically, a functional block diagram 400-A is shown of a comparator 406-A for evaluating a new or changed proxy metric 404-2 against a resource metric 404-1 of a merchant for possible routing options to a proxy solution and the merchant, according to one or more embodiments. Specifically, comparator 406 is coupled a given resource metric 402-1, e.g., from resource LL 220 in link library 214, and to a proxy metric 404-2, e.g., from proxy LL 222 in link library 214, and request LL 224. Referring now to FIG. 4B specifically, a functional block diagram 400-B is shown of a comparator 406-B for evaluating a new or changed proxy metric against a resource metric of a merchant for possible routing between a proxy solution and the merchant, according to one or more embodiments. Specifically, comparator 406-B is coupled a given request metric 410, e.g., from request LL 224 in link library 214, and to a metric 404, e.g., whether a proxy metric from proxy LL 222, or a resource metric from resource LL 220 in link library 214.

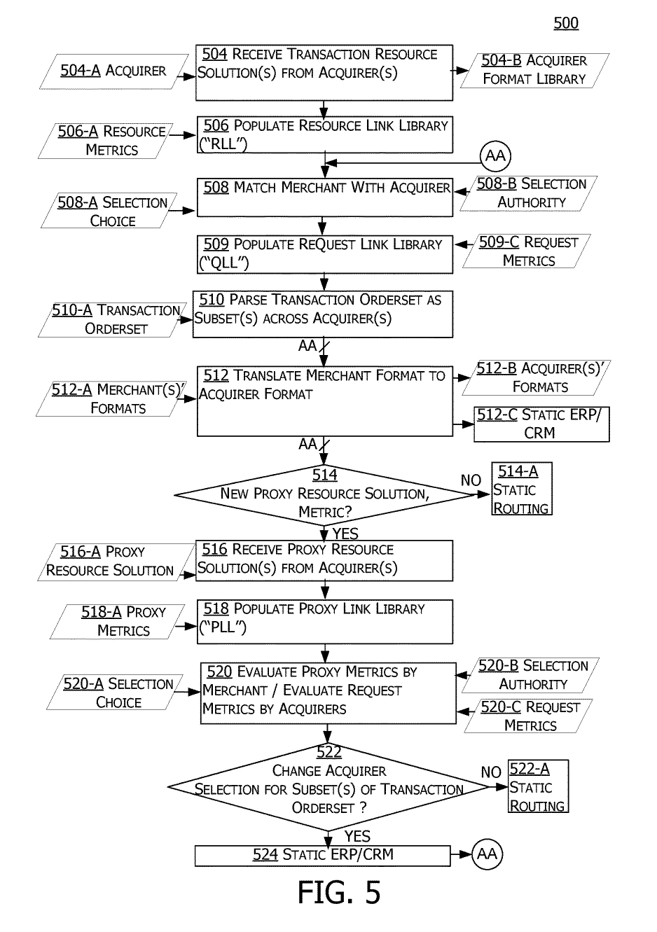

Referring now to FIG. 5, a flowchart is shown for routing merchant transactions to acquirers automatically, programmably, and flexibly within a payment system according to one or more embodiments.

In operation 504 a transaction resource solution is received at device 213 of FIG. 2 from one or more acquirers 201-1 thru 201-N via control lines C-A1 to C-AN, respectively, per FIG. 2, and as input 504-A in the present figure,

Operation 506 populates a database using resource metrics input 506-A, as provided by the owning acquirer. In one embodiment, this information builds an acquirer format library 504-B, implemented as resource link library (RLL) 220 of FIG. 2, and stored in one embodiment in memory 305 of FIG. 3.

For example, per Table 1 below, entitled “ACQUIRERS' Transaction Resource Solutions with RESOURCE Metrics”, acquirer companies Pursue, CoB (Choice of Bank), Planetpay, and 2^{nd} Info loaded their service offering plans A, standard (“Std.”) and premium (“Prem.”), A, and small office home office (“SOHO”) and Bluechip, respectively. All these different plans provide different capabilities, rates, and resource metrics. The format column provides device 213 with the ability to re-format incoming merchant transaction request to the proper format required by the acquirer chosen by the Merchant. Volume typically refers to daily volume, but can also be annual volume. In the table below, Pursue acquirer at IP address 01.01.01.111 has a single service “A” that can handle 10 M transactions daily, with a latency of 15 seconds (“s.”), is available worldwide, requires merchants to use a version “v2.5a” formatting in their transaction requests, and charges a 0.1% fee based on transaction amount, with other metrics specified in note “[A1]”. Other merchants have populated services and resource metrics as specified below.

TABLE 1
ACQUIRERS' Transaction Resource Solutions with RESOURCE Metrics

| | Acquirer | | Resource Metrics | | | | | |
|---|---|---|---|---|---|---|---|---|
| R | (IP Addr) | Service | Vol. | Latency | Location | Format | Cost | Other |
| 1 | Pursue | A | 10M | 15 s. | All | v. 2.5a | 0.1% | [A1] |
| | 01.01.01.111 | | | | | | | |
| 2 | CoB | Std. | 1M | | NA | SP 2.2 | 0.1% | [A2a] |
| | 01.01.01.111 | | | | | | | |
| | CoB | Prem. | Unltd. | | EU | | 0.1% | [A2b] |
| | 01.01.01.111 | | | | | | | |
| 3 | PlanetPay | A | 5M | — | Global | default | flat | [A3] |
| | 01.01.01.111 | | | | | | $5 | |
| 4 | 2^{nd} Info | Bluechip | Unltd. | | NA | Update | 0.1% | [A4a] |
| | 01.01.01.111 | | | | | 3 | | |
| 5 | 2^{nd} Info | SOHO | 5M | | SA | | 0.1% | [A4b] |
| | 01.01.01.111 | | | | | | | |

In operation 508, a merchant is matched with an acquirer. The matching is done either by legacy relationships and contracts, or by merchant making a selection choice 508-A or by a merchant giving selection authority 508-B to the intermediary service company (“Middleware”) that is operating the device 213. This step is implemented in FIGS. 2 and 3 as merchant 238 using input/output (“I/O”) 242 (e.g., similar to apparatus 314, 308, 310, but for merchant's PC) of his secure web portal 239 to view RLL 220 stored in link library of 214 device 213 via manual control line (“C-MAN”), e.g., an encrypted secure socket link with firewall protection, and to define her preferred business logic and layout, including hypothetical mock structuring and performance of different acquirers, in secure memory 240 (e.g., in similar memory 304, 305, 312, but in merchant's PC). In this manner, using device 213 as a physical intermediately, a free-market for transaction processing is now available to provide innovation and competition among acquirers, thereby bringing the best value and performance to merchants, and their clients. This process involves the specific enhanced performance of the electronic device 213 itself, and the electronic system of gateways, transaction interfaces, data storage and manipulation, etc. that is operated on the Internet and/or any type of network (LAN, MAN, SAN, WAN, etc.) to thereby improve efficiency and operation of the tangible devices and systems shown.

An exemplary selection might be as follows in Table 2 entitled “MERCHANTS' Selection of Acquirers”, where Lacy's chose CoB for their orderset 1, which is Lacy's entry level credit program for consumers, and chose PlanetPay for Lacy's Goldcard credit program for retail and business consumers. For merchant Marche de Mur, the acquirer column is listed as PlanetPay for subset A of Tx orderset 1, but is listed as “Auto” for subset B of orderset 1. The “Auto” refers to merchant Marche de Mur allowing Middleware to select the acquirers that ‘best fit’ the merchant per merchant's instructions provided as algorithm version 2.1, and communicated via automatic control line (“C-AUTO”) to the match engine 216 of FIG. 2. The control lines C-MAN and C-AUTO can both be sourced from a merchant's given PC connection and web portal 239, but are stored and implemented differently on device 213. An exemplary algorithm might empower Middleware via device 213 to select the lowest cost acquirer automatically, with switchover, or fail-over provisions for a different acquirer if acquirer resource metrics change, if merchant's needs change, or if latency or errors of a selected merchant exceed a specified threshold in the algorithm. Furthermore, the lowest cost acquirer might change over time, and depending upon transaction traffic, and location of sourcing transaction. Because device 213 can accommodate real-time, dynamic, and programmable routing of transactions to a plurality of different acquirers, with different formats, the merchant receives a turnkey, hands-free implementation of processing their transaction requests in a secure environment with transparency and feedback to the merchant. Contracts between Middleware and acquirers and/or merchant and acquirers will be harmonized to allow this type of flexibility and tradeoffs, not previously available. Furthermore, to enable this interchange between acquirers for a given merchant who preferably wants to retain a single format for his transaction requests, a means is needed to translate between the formats.

TABLE 2
MERCHANTS' Selection of Acquirers

| | | Tx | | | | | |
|---|---|---|---|---|---|---|---|
| R | Merchant | Orderset | Subset | Vol. | Latency | Acquirer | Results |
| 1 | Lacy's | 1 | — | 10M | 1 ms | CoB | |
| 2 | Lacy's | 2 | A | 1M | | PlanetPay | |
| | | (Goldcard) | | | | | |
| 3 | Lacy's | 2 | B | Unltd. | | 2^{nd} Data | |
| | | (Goldcard) | | | | | |
| 4 | PriceCo | 1 | — | | — | Pursue | |
| 5 | PriceCo | 2 | — | | | 2^{nd} Data | |
| 6 | Marché | 1 | A | Unltd. | | PlanetPay | |
| | de Mur | | | | | | |
| 7 | Marché | — | B | Vol. | Latency | (AUTO, | |
| | de Mur | | | | | Alg. 2.1) | |

Operation 509 populates a Request Link Library (“QLL”) with request metrics. Instead of a merchant selecting from a list of acquirers and their advertised performance and cost products, a merchant can instead provide her request metrics with a desired performance and cost. Then, either acquirers can agree to offer their services for the merchant-defined metrics, or the acquirer can bid on the merchant request metric, at some counter-offer metrics that might win a contract should no other acquirer be able to meet the request metrics. Step 509 is implemented by merchant entering data through her web portal 239 via C-MAN into a request LL 224 (received via device 213 and transaction gateway 212 devices 314 into memory 304-305, 312).

Exemplary Table 3 entitled “MERCHANTS' Transaction REQUEST Metrics” illustrates merchant's need for a service that is not currently satiated by the existing acquirers. For example, Lacy's has identified a new service they call internally ‘Delta’ that has This may be because of a new opportunity in a new market, new business relationship, a new consumer paradigm, etc. In Lacy's case, they want reduced cost of only 80% of a benchmarked competitor, or best in market. In exchange, they are open to ‘any’ format requirements, though this is moot with the Middleware device 213, which translates between formats. By allowing an online marketplace identifying merchants' needs, existing acquirers, or new and emerging acquirers can enter the market in a clearly defined manner. For example, Middleware and device 213 enables mobile and embedded device transactions, alternative currency means such as cryptocurrency and payment systems, etc. Other merchants define their request metrics as shown below.

TABLE 3
MERCHANTS' Transaction REQUEST Metrics

| | Acquirer | | Resource Metrics | | | | | |
|---|---|---|---|---|---|---|---|---|
| R | (IP Addr) | Service | Vol. | Latency | Loc. | Format | Cost | Other |
| 1 | Lacy's | Delta | 500K | 80-120% | All | any | 80% | [M1] |
| 2 | PriceCo | Beta | 1M | 70% | NA | New Std. | 100% | [M2] |
| 3 | Marché de Mur | Alpha. | Unltd. | 100% | E. | PlanetPay | 75% | [M3] |
| | | | | | Euro. | | | |

Operation 510 parses a transaction orderset as subsets across acquirers, after receiving a transaction orderset input 510-A. Thus, for example, whether merchant selects acquirers directly, or allows Middleware and device 213 to assign an acquirer, e.g., per Table 2, or if an acquirer and merchant come to agreement on a merchant's request metrics, per Table 3, then device 213, and match engine 216, implement said manual choices of acquirer and/or automatic choices of acquirer (i.e., by algorithm for an ‘auto’ selection). This operation is what allows the flexible, real-time, and dynamic changing of the acquirer for a given merchant's transaction orderset, or a subset therein. This operation may include an access to token exchange server 210.

Match engine 216 evaluates the incoming IP address of the transaction request and also opens the transaction request packet and reads the appropriate fields of the packet to evaluate the identity of the applicable acquirer. Then, match engine routes the transaction request to the applicable module, e.g., AQ1 module 202-1 if the acquirer chosen by the merchant is AQ1 Gateway 201-1.

Operation 512 translates the merchant format to the desired acquirer format, 512-B, according to the input merchant formats 512-A, which can be on a granularity as finely desired by the merchant, e.g., subset level based on any volume, location, etc. of transactions, as defined by request metrics, resource metrics, etc. The applicable module, e.g., AQ1 module 202-1 is programmed, as applicable, with the format requirements of acquirer AQ1 Gateway 201-1, reformats the transaction request in the packet and transmits the transaction request to the acquirer, e.g., AQ1 gateway 201-1. Fortunately, Middleware and device 213 leaves the ERP/CRM static, and makes no changes therein. Thus, the present disclosure is ERP/CRM-agnostic, enabling a further cross-platform solution that enhances productivity and competition in the PCI industry.

Below is an example of CRM/ERP server sending a payment request in an acquirer's direct XML request format to Middleware's HTTPS server. The request may contain a token instead of the actual personal account number (“PAN”), i.e., a card number.

Code 1. EXAMPLE Request received at Middleware.

<?xml version=“1.0” encoding=“UTF-8”?>
<TranxRequest>
<GatewayID>00004</GatewayID>
<Products>1.01::1::001::Test Product 1::{TEST}</Products>
<xxxName>John Smith</xxxName>
<xxxCompany>Customer Company</xxxCompany>
<xxxAddress>2201 Speers Road</xxxAddress>
<xxxCity>Buffalo</xxxCity>
<xxxState>NY</xxxState>
<xxxZipCode>123456</xxxZipCode>
<xxxCountry>US</xxxCountry>
<xxxPhone>9054696500</xxxPhone>
<xxxEmail>jsmith@customeraddress.com</xxxEmail>
<xxxShippingName> Joe Anyone</xxxShippingName>
<xxxShippingCompany>Recipient Company</xxxShippingCompany>
<xxxShippingAddress> 1000 Shipp Dr</xxxShippingAddress>
<xxxShippingCity>Amherst</xxxShippingCity>
<xxxShippingState>NY</xxxShippingState>
<xxxShippingZipCode>234567</xxxShippingZipCode>
<xxxShippingCountry>US</xxxShippingCountry>
<xxxShippingPhone>9054696510</xxxShippingPhone>
<xxxShippingEmail>janyone@shippingaddress.com</xxxShippingEmail
>
<xxxCard_Number>[token data]</xxxCard_Number>
<xxxCCMonth>12</xxxCCMonth>
<xxxCCYear>2011</xxxCCYear>
<CVV2>9999</CVV2>
<CVV2Indicator>1</CVV2Indicator>
<xxxTransType>00</xxxTransType>
</TranxRequest>

Upon receipt of the code, Middleware at device 213 sends the token data to the token exchange server 210. The token exchange server returns the de-tokenized card number, and Middleware replaces the [Token Data] with the de-tokenized, real Card Number, and forwards the request to acquirer's direct XML HTTPS Server. Below is an exemplary coding.

Code 2. EXAMPLE de-tokenized card number to acquirer.

<?xml version=“1.0” encoding=“UTF-8”?>
<TranxRequest>
<GatewayID>00004</GatewayID>
<Products>1.01::1::001::Test Product 1::{TEST}</Products>
<xxxName>John Smith</xxxName>
<xxxCompany>Customer Company</xxxCompany>
<xxxAddress> 2201 Speers Road</xxxAddress>
<xxxCity>Buffalo</xxxCity>
<xxxState>NY</xxxState>
<xxxZipCode>123456</xxxZipCode>
<xxxCountry>US</xxxCountry>
<xxxPhone>9054696500</xxxPhone>
<xxxEmail>jsmith@customeraddress.com</xxxEmail>
<xxxShippingName> Joe Anyone</xxxShippingName>
<xxxShippingCompany>Recipient Company</xxxShippingCompany>
<xxxShippingAddress> 1000 Shipp Dr</xxxShippingAddress>
<xxxShippingCity>Amherst</xxxShippingCity>
<xxxShippingState>NY</xxxShippingState>
<xxxShippingZipCode>234567</xxxShippingZipCode>
<xxxShippingCountry>US</xxxShippingCountry>
<xxxShippingPhone>9054696510</xxxShippingPhone>
<xxxShippingEmail>janyone@shippingaddress.com</xxxShippingEmail
>
<xxxCard_Number>4500000000000001</xxxCard_Number>
<xxxCCMonth>12</xxxCCMonth>
<xxxCCYear>2011</xxxCCYear>
<CVV2>9999</CVV2>
<CVV2Indicator>1</CVV2Indicator>
<xxxTransType>00</xxxTransType>
</TranxRequest>

The acquirer's Merchant Direct gateway returns a response, which as per their spec does not contain clear text account number. However, the Middleware will check, and if account number is present it will tokenize it and replace the token value in the response before returning it back, as illustrated in exemplary Code 3 example. This adds an extra layer of safety in the transaction process to prevent the unauthorized disclosure of a PAN.

Code 3. EXAMPLE de-tokenized card number to acquirer.

<?xml version=“1.0” encoding=“UTF-8”?>
<TranxResponse>
<GatewayID>00004</GatewayID>
<ReceiptNumber>1096019995.50D2</ReceiptNumber>
<SalesOrderNumber>500</SalesOrderNumber>
<xxxName>John Smith</xxxName>
<xxxCompany>Customer Company</xxxCompany>
<xxxAddress>2201 Speers Road</xxxAddress>
<xxxCity>Buffalo</xxxCity>
<xxxState>NY</xxxState>
<xxxZipCode>123456</xxxZipCode>
<xxxCountry>US</xxxCountry>
<xxxPhone>8666388789</xxxPhone>
<xxxEmail>jsmith@customeraddress.com</xxxEmail>
<Date>2007/12/17 09:59:58</Date>
<CardType>VI</CardType>
<Language>EN_US ;ISO-8859-1</Language>
<Page>90000</Page>
<ApprovalCode>123456</ApprovalCode>
<Verbiage> Approved</Verbiage>
<TotalAmount>1.01</TotalAmount>
<Products>
<product>
<code>PC-01</code>
<description> Test Product</description>
<quantity>1</quantity>
<price>1.01</price>
<subtotal>1.01</subtotal>
</product>
</Products>
<DoubleColonProducts>1.01::1::PC-01::Test
Product::</DoubleColonProducts>
<AVSResponseCode>U</AVSResponseCode>
<CVV2ResponseCode>M</CVV2ResponseCode>
<xxxAmount>1.01</xxxAmount>
<xxxHostResponseMessage>APPROVAL</xxxHostResponseMessage>
<xxxTransType>00</xxxTransType>
<GUID>e1d19676-6e12-327b-de96-dfeaOcc647a5</GUID>
</TranxResponse>

Operation 514 inquires whether a new proxy resource solution or metric has arisen. If negative, then the routing remains static 514-A between merchants and acquirers. If positive, then operation 516 receives the proxy resource solution input 516-A from acquirers, and populates in operation 518 the proxy link library (“QLL”) with the proxy metrics input 518-A, as illustrated by Table 4 embodiment below, entitled “PROXYS' Resource Solutions with PROXY Metrics”. The term ‘proxy’ can refer to a new acquirer that is not currently engaged with a merchant in a given market, or it can refer to an existing acquirer that wants to offer a new product. By displaying the proxy metrics in the QLL, the proxy can advertise her services in the link library 214 for authorized merchants to peruse and evaluate for engagement. As shown in exemplary Table 4, NewGuy is providing a cost-reduced solution, at only 80% the cost of a benchmark value, but adds 50% latency to the baseline industry value, thus running at 150% latency. Other proxy metrics are specified in ‘other’ column, which can affect any aspect of the acquirer service.

TABLE 4
PROXYS' Resource Solutions with PROXY Metrics

| | | | Proxy Metrics | | | | | |
|---|---|---|---|---|---|---|---|---|
| | Acquirer | Ser- | | Laten- | Loca- | | | |
| R | (IP Addr) | vice | Vol. | cy | tion | Format | Cost | Other |
| 1 | NewGuy | A | 10M | 150% | All | v1 | 80% | [P1] |
| | 01.01.01.123 | | | | | | | |
| 2 | ValueGuy | Std. | 1M | | NA | SP 2.2 | 100% | [P2a] |
| | 01.01.01.456 | | | | | | | |
| 3 | ValueGuy | Prem. | Unltd. | | EU | | 75% | [P2b] |
| | 01.01.01.456 | | | | | | | |
| | InnovateGuy | A | | — | Global | default | 125% | [P3] |
| | 01.01.01.789 | | | | | | | |

In operation 520, the proxy metrics are evaluated by the merchant and/or the request metrics are evaluated by acquirers. If a proxy metric appears attractive to a merchant, the merchant may select the proxy metric manually via input 520-A or automatically, per input 520-B selection authority being given to Middleware and device 213, and implemented per an algorithm as described above. The proxy acquirer service can be used for a subset of a transaction orderset, or the entire transaction orderset. Typically, a merchant would prefer to run a beta test on a new acquirer using only a fraction, say 1-10%, of the merchant's transaction orderset. In this way, if the proxy performance is poor, then only a small fraction of merchant's orders will be adversely affected. Moreover, because of the flexibility of Middleware and device 213, a transfer back from a test proxy service to a prior established acquirer service can be immediate and without merchant reformatting of transaction requests and without changing ERP/CRP systems.

In operation 522, an inquiry asks whether to change an acquirer selection of a merchant's transaction orderset. If negative, then the routing remains static 522-A. If positive, and if the selection choice or authority was correctly presented in the above step, then an optional authorization or handshake protocol may be used to verify the change in acquirers before implementing. Else, the change is effected at the time/location, event, as specified by the merchant, or as specified by Middleware policy. This is implemented by Middleware updating a secure lookup table reference in a secure memory section, e.g., 304, 305, or 312 of FIG. 3) of transaction gateway 212. A buffer portion of memory temporarily stores incoming transaction requests while the change in the acquirer is made. Once effective, transaction gateway 212 will re-route, for example, the incoming transaction requests to acquirer AQ2 gateway 201-2 instead of the prior gateway of AQ1 201-1.

TABLE 5
MERCHANTS' Updated Selection of Acquirers

| | | Tx | | | | | |
|---|---|---|---|---|---|---|---|
| R | Merchant | Orderset | Subset | Vol. | Latency | Acquirer | Results |
| 1 | Lacy's | 1 | — | 10M | 1 ms | CoB | |
| 2 | Lacy' | 2 | A | 1M | | PlanetPay | |
| | | (Goldcard) | | | | | |
| 3 | Lacy's | 2 | B | Unltd. | | 2^{nd} Data | |
| | | (Goldcard) | | | | | |
| 4 | PriceCo | 1 | — | | — | Pursue | |
| 5 | PriceCo | 2 | — | | | 2^{nd} Data | |
| 6 | Marché | 1 | A | Unltd. | | PlanetPay | |
| | de Mur | | | | | | |
| 7 | Marché | — | B | Vol. | Latency | (AUTO, | |
| | de Mur | | | | | Alg. 2.1) | |

Thus, in summary for the Middleware and electronic device 213, implemented in method 500, an enabling written description has been provided for routing merchant transactions to acquirers automatically, programmably, and flexibly within a payment system, according to one or more embodiments. This enables new productivity levels and innovative programs for acquirers, proxies, merchants, and ultimately, consumers.

### Applications

References to methods, operations, processes, systems, and apparatuses disclosed herein that are implementable in any means for achieving various aspects, and may be executed in a form of a machine-readable medium, e.g., computer readable medium, embodying a set of instructions that, when executed by a machine such as a processor in a computer, server, etc. cause the machine to perform any of the operations or functions disclosed herein. Functions or operations may include receiving, intercepting, processing, encoding, decoding, transmitting, converting, communicating, transforming, synchronizing, calculating, terminating, compiling, associating, and the like.

The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly be taken to include, but not limited to, solid-state memories, optical and magnetic media, compact disc and any other storage device that can retain or store the instructions and information, e.g., only non-transitory tangible medium. The present disclosure is capable of implementing methods and processes described herein using transitory signals as well, e.g., electrical, optical, and other signals in any format and protocol that convey the instructions, algorithms, etc. to implement the present processes and methods.

Exemplary computing systems, such as a personal computer, minicomputer, mainframe, server, etc. that are capable of executing instructions to accomplish any of the functions described herein include components such as a processor, e.g., single or multi-processor core, for processing data and instructions, coupled to memory for storing information, data, and instructions, where the memory can be computer usable volatile memory, e.g. random access memory (RAM), and/or computer usable non-volatile memory, e.g. read only memory (ROM), and/or data storage, e.g., a magnetic or optical disk and disk drive). Computing system also includes optional inputs, such as alphanumeric input device including alphanumeric and function keys, or cursor control device for communicating user input information and command selections to processor, an optional display device coupled to bus for displaying information, an optional input/output (I/O) device for coupling system with external entities, such as a modem for enabling wired or wireless communications between system and an external network such as, but not limited to, the Internet. Coupling of components can be accomplished by any method that communicates information, e.g., wired or wireless connections, electrical or optical, address/data bus or lines, etc.

The computing system is only one example of a suitable computing environment and is not intended to suggest any limitation as to the scope of use or functionality of the present technology. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The present disclosure is applicable to any type of network including the Internet, an intranet, and other networks such as local are network (LAN); home area network (HAN), virtual private network (VPN), campus area network (CAN), metropolitan area network (MAN), wide area network (WAN), backbone network (BN), global area network (GAN), or an interplanetary Internet. Communication media in the system can include wired, optical, wireless and other communication systems, e.g., voice over internet protocol (VOIP) that conveys data.

Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained.

Although the present embodiments have been described with reference to specific example embodiments, it will be evident that various modifications and changes may be made to these embodiments without departing from the broader spirit and scope of the various embodiments.

For example, the various devices, modules, encoders, decoders, receivers, transmitters, servers, wireless devices, internal commutation systems, computers, etc. described herein may be enabled and operated using hardware circuitry (e.g., CMOS based logic circuitry), firmware, software and/or any combination of hardware, firmware, and/or software (e.g., embodied in a machine readable medium). Similarly, the modules disclosed herein may be enabled using software programming techniques. For example, the various electrical structure and methods may be embodied using transistors, logic gates, and electrical circuits (e.g., application specific integrated ASIC circuitry and/or in Digital Signal; Processor DSP circuitry).

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles of the invention and its practical application, to enable others skilled in the art to best utilize the invention and various embodiments with various modifications as are suited to the particular use contemplated. It is intended that the scope of the invention be defined by the Claims appended hereto and their equivalents.

I claim:

1. An electronic transaction device for routing merchant transactions to acquirers, the electronic device comprising:
a transaction gateway computer (“TGC”) for coupling one or more transaction acquirers with one or more merchants;
a resource link library (“RLL”) comprising a plurality of transaction resource solutions (“TRS”) from one or more acquirers, with each TRS having a plurality of resource metrics; and
a match engine (“ME”); and wherein:
the match engine is configured to parse a given transaction orderset (“TO”) from a merchant across one or more acquirers simultaneously via the transaction gateway computer based on at least one of the plurality of resource metrics.

2. The electronic transaction device of claim 1 further comprising:
a translator logic for translating a merchant transaction format to one or more different acquirer transaction formats; and wherein:
the translator logic translates in parallel at least one subset of the given transaction orderset to a transaction format that is different than a transaction format of another subset of the given TO;
the merchant transaction format for the transaction orderset is not required to be changed; and
the translator is programmable to modify the at least one subset of the given transaction orderset from a first format to a second format in real time.

3. The electronic transaction device of claim 1 wherein:
the ME selectively and simultaneously parses the given transaction orderset as:
a first subset of a given merchant to a first transaction acquirer based on at least one of a plurality of resource metrics of the first transaction acquirer that satisfies at least one of a first set of request metrics of the given merchant; and
a second subset of the given merchant to a second transaction acquirer based on at least one of a plurality of resource metrics for the second acquirer satisfying at least one of a second set of request metrics of the given merchant.

4. The electronic transaction device of claim 3 wherein:
the ME selectively reroutes the parsing of the given transaction orderset in real time from a first set of one or more acquirers at a first set of IP addresses to a second set of one or more acquirers at a second set of IP address, where at least one of the acquirers in the second set is different from those in the first set; and
the rerouting by the match engine does not require changing an underlying resource planning system.

5. The electronic transaction device of claim 1 further comprising:
a proxy link library (“PLL”) comprising at least one proxy resource solution (“PRS”) of an acquirer, with each proxy solution having a plurality of proxy metrics.

6. The electronic transaction device of claim 5 wherein:
the match engine comprises a comparative logic; and wherein:
the match engine identifies when a change is made to a proxy metric and when a new proxy resource solution is entered in the PLL;
the comparative logic compares the new or changed proxy metrics against resource metrics in the RLL;
the match engine receives an instruction from a user to implement a supra proxy resource solution that has at least one proxy metric that exceeds a resource transaction solution; and
the match engine substitutes the PRS for the TRS by rerouting the parsing of the given transaction orderset in real time.

7. The electronic transaction device of claim 5 further comprising:
a request link library (“QLL”) comprising one or more transaction request ordersets from one or more merchants, with each transaction request orderset having a plurality of request metrics.

8. The electronic transaction device of claim 6 wherein:
the match engine automatically implements the supra proxy solution based on a match level set by the supra proxy solution is implemented for at least one subset of the given transaction orderset of a given merchant.

9. The electronic transaction device of claim 7 further comprising:
a token interface coupled to the transaction gateway; and wherein:
the token interface communicates with a token as a service (“TAAS”) exchange on the input interface, associates the token with the given acquirer; and transmits the transaction and the token from the output interface to a banking intuition for further processing.

10. A transaction system for routing merchant transactions to acquirers, the electronic system comprising:
an electronic transaction device comprising:
a transaction gateway computer (“TGC”) for coupling one or more transaction acquirers with one or more merchants;
a resource link library (“RLL”) comprising a plurality of transaction resource solutions (“TRS”) from one or more acquirers, with each TRS having a plurality of resource metrics; and
a match engine (“ME”); and wherein:
the match engine is configured to parse a given transaction orderset (“TO”) from a merchant across one or more acquirers simultaneously via the transaction gateway computer based on at least one of the plurality of resource metrics; and
one or more acquirer gateways coupled to the electronic device, wherein the acquirer gateways process transactions into a merchant institution.

11. The transaction system of claim 10 wherein the electronic transaction device further includes:
a translator logic for translating a merchant transaction protocol format to one or more different acquirer transaction formats; and wherein:
the translator logic translates in parallel at least one subset of the given transaction orderset to a transaction format that is different than a transaction format of another subset of the given TO;
the merchant transaction format for the transaction orderset is not required to be changed;
the translator is programmable to modify the at least one subset of the given transaction orderset from a first format to a second format in real time.

12. The transaction system of claim 10 wherein:
the ME of the electronic transaction device selectively and simultaneously parses the given transaction orderset as:
a first subset of a given merchant to a first transaction acquirer based on at least one of a plurality of resource metrics of the first transaction acquirer that satisfies at least one of a first set of request metrics of the given merchant; and
a second subset of the given merchant to a second transaction acquirer based on at least one of a plurality of resource metrics for the second acquirer satisfying at least one of a second set of request metrics of the given merchant.

13. The transaction system of claim 12 wherein:
the match engine of the electronic transaction device selectively reroutes the parsing of the given transaction orderset in real time from a first set of one or more acquirers at a first set of IP addresses to a second set of one or more acquirers at a second set of IP address, where at least one of the acquirers in the second set is different from those in the first set; and
the rerouting by the match engine does not require changing an underlying resource planning system.

14. The transaction system of claim 10 wherein the electronic transaction device further includes:
a proxy link library (“PLL”) comprising at least one proxy resource solution (“PRS”) of an acquirer, with each proxy solution having a plurality of proxy metrics.

15. The transaction system of claim 14 wherein the electronic transaction device further comprises:
a request link library (“QLL”) comprising one or more transaction request ordersets from one or more merchants, with each transaction request orderset having a plurality of request metrics.

16. The transaction system of claim 15 wherein:
the match engine of the electronic transaction device automatically implements the supra proxy solution based on a match level set by the supra proxy solution is implemented for at least one subset of the given transaction orderset of a given merchant.

17. The transaction system of claim 15 further comprising:
a token exchange server providing tokenization as a service (“TAAS”); and wherein the electronic transaction device further includes:
a token interface coupled to the transaction gateway; and wherein:
the token interface communicates with a token exchange server on the input interface, associates the token with the given acquirer; and transmits the transaction and the token from the output interface to a banking intuition for further processing.

18. A method for routing merchant transactions to acquirers, the method comprising:
an electronic transaction device comprising:
populating a resource link library (“RLL”) with one or more transaction resource solutions (“TRS”) received from one or more acquirers, with each TRS having a plurality of resource metrics;
parsing via a match engine (“ME”) a given transaction orderset (“TO”) from a merchant into one or more subsets across one or more acquirers simultaneously via a transaction gateway computer (“TGC”) based on at least one of the plurality of resource metrics; and
coupling via a transaction gateway computer (“TGC”), a one or more transaction acquirers with one or more merchants; and
translating via translator logic a merchant transaction format or more different acquirer transaction formats; and wherein:
the translator logic translates in parallel at least one subset of the given transaction orderset to a transaction format that is different than a transaction format of another subset of the given TO;
the merchant transaction format for the transaction orderset is not required to be changed; and
the translator is programmable to modify the at least one subset of the given transaction orderset from a first format to a second format in real time.

19. The method of claim 18 further comprising:
populating a proxy link library (“PLL”) comprising at least one proxy resource solution (“PRS”) of an acquirer, with each proxy solution having a plurality of proxy metrics;
identifying via the match engine when a change is made to a proxy metric and when a new proxy resource solution is entered in the PLL;
comparing the new or changed proxy metrics against resource metrics in the RLL; and
receiving an instruction from a user to implement a proxy resource solution that has at least one proxy metric that exceeds a resource transaction solution;
substituting the PRS for the TRS by rerouting the parsing of the given transaction orderset in real time.
rerouting the ME selectively the parsing of the given transaction orderset in real time from a first set of one or more acquirers at a first set of IP addresses to a second set of one or more acquirers at a second set of IP address, where at least one of the acquirers in the second set is different from those in the first set; and wherein:
the rerouting by the match engine does not require changing an underlying resource planning system.

20. The method of claim 18 further comprising:
populating a request link library (“QLL”) comprising one or more transaction request ordersets from one or more merchants, with each transaction request orderset having a plurality of request metrics;
automatically implementing a supra proxy solution via the match engine based on a match level between a RLL and a QLL for the supra proxy solution for at least one subset of the given transaction orderset of a given merchant.
